(19) United States
(12) Patent Application Publication
(10) Pub. No.: US 2005/0174085 A1
(43) Pub. Date: Aug. 11, 2005

(54) Micromanipulation system

(75) Inventor: Kiyoshi Yuri, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Olympus Corporation, Tokyo (JP)

(21) Appl. No.: 11/053,122

(22) Filed: Feb. 7, 2005

(30) Foreign Application Priority Data
Feb. 10, 2004 (JP) 2004-33031

(51) Int. Cl. G05B 1/06

(52) U.S. Cl. 318/640

(57) ABSTRACT

A micromanipulation system for applying a micro manipulation to an object within the view of a microscope, using a fine needle, comprising: a manipulator driving unit for transferring the fine needle at least along the optic axis direction of the microscope, a micro manipulation starting position determining unit for determining a micro manipulation starting position as a reference position, an object transfer unit for relatively transferring the respective positions of the object and object lens, a focus position detecting unit for detecting a focus position indicating the focus of the object in the object lens, in accordance with the relative transfer of the object, an object transfer control unit for controlling a movement of the object transfer unit, based on the detection result, and a micro manipulation control unit for performing the micro manipulation.

### CROSS REFERENCE TO RELATED APPLICATION

This application is based on and claims the benefit of priority of the prior Japanese Patent Application No. 2004-33031 filed in Japan on Feb. 10, 2004, the entire contents of which are incorporated by this reference.

### FIELD OF THE INVENTION

The present invention relates to a micromanipulation system, and more particularly to a micromanipulation system provided with a microscope and a micromanipulator for operations in minute scales (that is, micro manipulation), such as three-dimensional transfer of a fine needle, injection/absorption and the like within the view of the microscope.

### DESCRIPTION OF THE RELATED ART

For example, when injecting a DNA solution into a specimen, such as a cell, an egg or the like, a micromanipulation system provided with a micromanipulator and a microscope is used. In the micromanipulator, a fine needle is disposed to inject the DNA solution or the like into the specimen and the microscope is used to observe the injection.

In a typical micromanipulation system, a microscopic instrument, such as a fine needle is manipulated within the view of the microscope, and its picture is shown on a CRT display. The fine needle is inserted into the microscopic specimen, such as a cell, an egg or the like which is placed in a container, such as a Schale (laboratory dish) or the like, while observing the displayed contents and a prescribed process is performed.

Conventionally, these processes have been manually performed. However, if there are many target fine specimens, precise work, such as aligning the position of the fine needle with each specimen and inserting the needle into the specimen must be executed consecutively. Thus, the operator load is high, and an improvement in operability is desired.

More particularly, alignment in the Z-axis direction must be determined based on the degree of blurring of focuses of the specimen and the needle in the microscope picture. Therefore, the alignment in the vertical direction requires experience and skill, which is a problem in operation for many operators.

In order to improve the operability of the alignment of the needle and specimen, technologies for automatically aligning them using an electro-motive specimen stage and a micromanipulator have been presented.

For example, Japanese Patent Application Laid-open No. Hei 01-3560 discloses a technology for automatically calculating coordinates of a stage on which a specimen exists when indicating the position of the specimen on a monitor, aligning the specimen and inserting a fine needle into the specimen. Japanese Patent Application Laid-open No. Hei 06-109979 discloses a technology for simplifying the respective height adjustments of a specimen and a fine needle by displaying the vertical position of a micromanipulator.

### SUMMARY OF THE INVENTION

The micromanipulation system of the present invention, for applying a micro manipulation to an object within the view of a microscope, using a fine needle, comprises the following units:
a manipulator driving unit for transferring the fine needle at least along the optic axis direction of the microscope,
a micro manipulation starting position determining unit for determining a micro manipulation starting position, from which the micro manipulation starts, using a position, on which the tip of the fine needle is focused in an object lens, as a reference position,
an object transfer unit for relatively transferring the respective positions of the object and object lens,
a focus position detecting unit for detecting a focus position indicating the focus of the object in the object lens, in accordance with the relative transfer of the object by the object transfer unit,
an object transfer control unit for controlling a movement of the object transfer unit, based on a detection result of the focus position detecting unit, and
a micro manipulation control unit for performing the micro manipulation in a state where the object is transferred to the focus position by the object transfer control unit and the fine needle is transferred to the micro manipulation starting position.

A computer data signal embodied in a carrier wave, for controlling the micromanipulation system of the present invention, for applying a micro manipulation to an object within the view of a microscope, using a fine needle, enables a computer to execute the following processes:
a manipulator driving process of transferring the fine needle at least along the optic axis direction of the microscope,
a micro manipulation starting position determining process of determining a micro manipulation starting position, from which a micro manipulation starts, using a position, on which the tip of the fine needle is focused in an object lens, as a reference position,
an object transfer process of relatively transferring the respective positions of the object and object lens,
a focus position detecting process of detecting a focus position indicating the focus of the object in the object lens, in accordance with the relative transfer of the object by the object transfer unit,
an object transfer control process of controlling a movement of the object transfer unit, based on a detection result of the focus position detecting unit, and
a micro manipulation control process of performing the micro manipulation in a state where the object is transferred to the focus position by the object transfer control process and the fine needle is transferred to the micro manipulation starting position.

A micromanipulation system control method for applying a micro manipulation to an object within the view of a microscope, using a fine needle, comprises the following steps of:
transferring the fine needle along the optic axis direction of the microscope;
determining a micro manipulation starting position, which is the optic axis direction position of the fine needle that starts the micro manipulation, using a optic axis direction position on which the tip of the fine needle is focused in an object lens as a reference position;
detecting a focus position indicating a position on which the object is focused in the object lens;
relatively transferring the respective positions of the object and the object lens position based on the result of the detection, and focusing the object on the object lens;
transferring the fine needle to the micro manipulation starting position; and
performing and controlling the micro manipulation.

### BRIEF DESCRIPTION OF THE DRAWINGS

FIG. 1 shows the entire configuration of the micromanipulation system in the first preferred embodiment.

FIG. 2 is a flowchart showing the process of the first preferred embodiment.

FIG. 3 explains the vertical adjustment of a specimen and a fine needle in the first preferred embodiment.

FIG. 4 explains the calculation of a contrast value in the first preferred embodiment.

FIG. 5 shows an area A whose center is an injection position, in the second preferred embodiment.

FIG. 6 shows the process flow of the second preferred embodiment.

FIG. 7 shows the process flow of the third preferred embodiment.

FIG. 8 shows the process flow of the fourth preferred embodiment.

FIG. 9 shows the process of updating a contrast evaluation area according to the transfer of a specimen in the fourth preferred embodiment.

### DESCRIPTION OF THE PREFERRED EMBODIMENTS

### The First Preferred Embodiment

In the present invention, even for a plurality of specimens each of different height, a manipulator can be automatically operated. For that purpose as an initial process, the position where the tip of a fine needle is focused in an object lens is registered as the Z-direction reference position of a manipulator driving unit.

In this preferred embodiment, if each specimen has a different height, during a focusing process, the height of the injection position of each specimen is controlled so that the contrast value attains a maximum value across the entire specimen picture data.

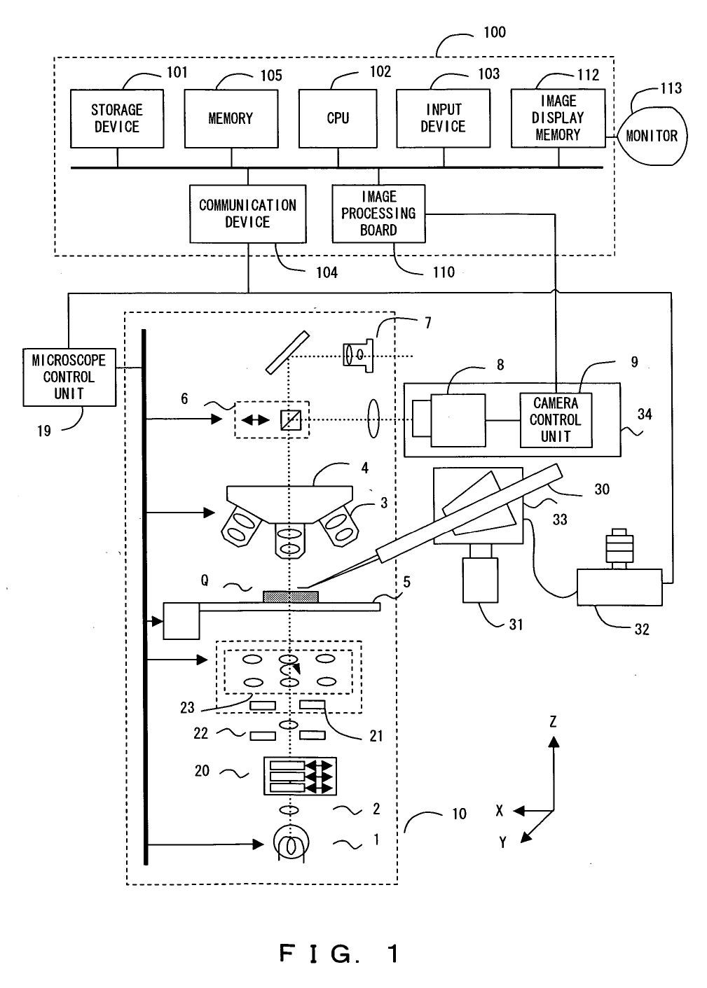

FIG. 1 shows the entire configuration of the micromanipulation system in this preferred embodiment. This system mainly comprises a microscope unit 10, micromanipulator unit (including 30, 31, 32 and 33), a camera unit 34, a computer 100 and an image monitor 113.

The microscope unit 10 optically captures a microscopic image from a specimen container Q which accommodates a specimen, such as an egg, a cell or the like, at a desired magnification. The micromanipulator unit (including 30, 31, 32 and 33) three-dimensionally transfers a fine needle, injects an injection solution and suctions a cell within the view of the microscope, using the fine needle. The camera unit 34 converts the observed image of the specimen into electronic image signals. The computer 100 forms a highly magnified image from the image signals, and outputs a control signal to each unit, based on the image. The image monitor 113 displays the formed image and an operation screen.

The microscope unit 10 has a specimen stage 5 for mounting the specimen container Q containing a specimen K to be manipulated. Below the specimen stage 5 are deployed a transmission filter unit 20, a transmission field stop 21, a transmission aperture stop 22, an optical condenser device unit 23 and a transmission illumination light source 1, for example, a halogen lamp. The transmission illumination light source 1 illuminates the specimen container Q on the specimen stage from below.

On the optical axis of the observation path above the specimen stage 5, a revolver 4 and an observation beam splitter 6 are disposed. The revolver 4 is used to switch a plurality of object lenses 3a-3f. The observation beam splitter 6 is used to split the observed specimen image into two beams. This observation beam splitter 6 splits the observation light path into two beams. An eyepiece 7 is disposed in one observation light path, and a camera head 8 is provided in the other light path. The microscope unit 10 also comprises a microscope control unit 19 for controlling all the microscope components.

In the microscope 10 configured so, illumination generated by the transmission illumination light source 1 is collected by a collector lens 2 and is input to the transmission filter unit 20. The transmission filter unit 20 adjusts the illumination. The adjusted illumination illuminates a specimen (in specimen container Q) from below of the illumination aperture unit of the specimen stage 5 through the transmission field stop 21, the transmission aperture stop 22 and the optical condenser device unit 23.

The microscope control unit 19 controls the transfer along the optic axis relative to the specimen stage 5 to focus the specimen, and also in a plane formed by the two horizontal dimensions orthogonal to be optic axis of the microscope to modify the observation point of the specimen container Q. Simultaneously, the microscope control unit 19 can detect its position in each direction.

The light (observed specimen image) that is transmitted through the specimen (in the specimen container Q) and is collected by the object lens 3 is directed to the camera head 8 through the observation beam splitter 6. The camera unit 34 comprises the camera head 8 and a camera control unit 9. The camera head 8 comprises a solid-state imaging device and an optical image formation system. The solid-state imaging device is made up of, for example, a charge modulation device (CMD). The optical image formation system forms an image of the light which is transmitted through the specimen and onto the CMD.

The camera control unit 9 comprises an automatic gain control (AGC) amplifier to automatically adjust the gain of the amplifier (ie the output voltage of the camera control unit 9). Then, the camera control unit 9 which controls the camera head 8 transfers analog image data from the camera head 8 to an image processing board 110.

The image processing board 110 digitizes, the analog image data, JPEG-compresses it, and stores it. The stored digital image data is transferred to image display memory 112 and displayed on the image monitor 113.

In each of the micromanipulator unit (including 30, 31, 32 and 33), an arm 31 with the instrument holder 30 at its distal end is provided and projected on an operation console side. The instrument holder 30 holds microscopic instruments, such as injection pipettes, suction pipettes and the like.

The driving mechanism 33 is comprised for horizontal directions (X and Y directions) and a vertical direction (Z direction) in order to transfer a microscopic instrument held by the instrument holder 30. This driving mechanism comprises an X-axis stepper motor, a Y-axis stepper motor, a Z-axis stepper motor and a guide rail. The X, Y and Z-axis stepping motors drive the X, Y and Z-axis directions, respectively. The guide rail guides the instrument holder 30 in the X, Y and Z-axis directions in accordance with the drive of each motor. This driving mechanism 33 can detect the position in each dimension.

A micromanipulator operation unit 32 comprises a joystick. This joystick can be inclined 36 degrees to the vertical, and controls the transfer (X and Y directions) of the micromanipulator.

On top of the joystick is a rotary dial. By operating this rotary dial, the height (Z-axis direction) of the micromanipulator can be controlled. The micromanipulator operation unit 32 comprises a key switch for switching between a manual mode and a PC control mode. In the manual mode, the joystick controls the micromanipulator. In the PC control mode, the micromanipulator is controlled by signals received from the computer 100 connected to the micromanipulator operation unit 32.

The computer 100 comprises a storage device 101, memory 105, a central processing unit (CPU) 102, an input device 103, a communication device 104, image display memory 112 and an image processing board 110.

The storage device 101 and memory 105 store programs and control data for performing a variety of system operations and processes. The CPU 102 performs image processing. CPU performs other processes, too. The input device 103, a mouse, a keyboard and the like are used. The communication device 104 communicates instruction to the microscope to rotate the revolver, to transfer the specimen stage 5 and the like, and the micromanipulator unit to transfer in the X, Y and Z-axis directions and the like. The microscope control unit 19 receives a variety of instructions from the communication device 104 of the computer 100 and controls each corresponding component of the microscope (such as a transfer of the specimen stage 5 in the X, Y or Z-axis direction).

The image processing board 110 digitizes analog image data, JPEG-compresses image data and stores it, as described above. The stored digital image data is transferred to the image display memory 112 and is displayed on the image monitor 113.

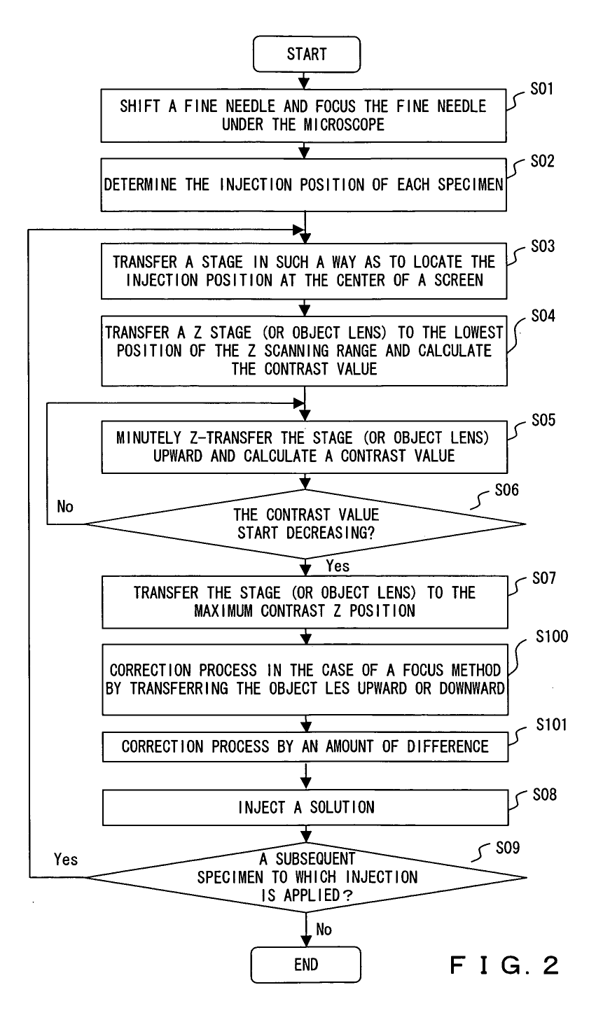

FIG. 2 is the process flow of this preferred embodiment. In FIG. 2, in order to inject a solution at the simultaneously height where a specimen and a fine needle are focused, the position at which the fine needle is focused is stored as the reference position in the manipulator driving. Thus, the fine needle can be repositioned to the focused position at the time of injection. Specimen height is automatically adjusted in such a way that the contrast value of a microscope image is maximized by controlling the height of the specimen. The process of this preferred embodiment is described below with reference to the drawings.

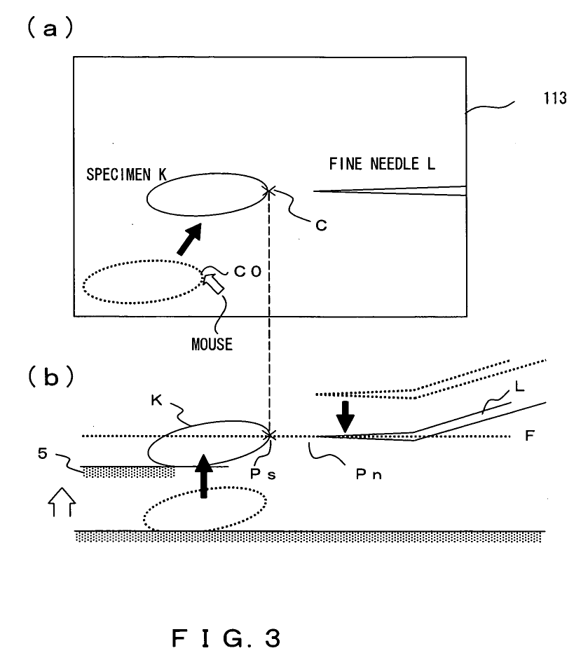

FIG. 3 explains the respective focusing processes of a specimen and a fine needle in this preferred embodiment. Firstly, a fine needle L is horizontally transferred by the driving mechanism 33 of the micromanipulator, and as shown in FIG. 3(a), the tip of the fine needle L is almost located close to the center of a microscopic image displayed on the image monitor 113.

The fine needle L is transferred in the Z-axis direction by the driving mechanism 33 of the micromanipulator while observing the microscope image to focus the tip of the fine needle. In this case, the vertical position of the tip of the needle transfers to plane the plane of F as shown in FIG. 3B. The XYZ -coordinate value of the micromanipulator driving mechanism 33 in the focused position Pn of the fine needle, obtained here is stored as a reference position (S01). Thus, the position Pn of the fine needle L, obtained here can be reproduced when a solution is injected into a specimen.

Then, as shown in FIG. 3(a), on the microscope image displayed on the image monitor 113, a mouse cursor is transferred to a position C0 where the fine needle L is inserted into a specimen K (hereinafter called an “injection position”), and the position C0 is specified by clicking the mouse. The CPU 102 acquires coordinate data displayed on the image monitor 113 of the position C0 and converts the data into the coordinate data of the stage 5 (S02). In this case, if there is a plurality of specimens spread over a wide area, it is efficient to firstly photograph the entire image at low magnification and to collectively specify the plurality of specimens displayed on the image. Then, the driving mechanism 33 of the micromanipulator retreats the fine needle before the stage 5 transfers.

The stage 5 is transferred on the XY plane in such a way that the injection position C0 of the specimen specified in S02 may be located at the center C of the microscope image, using the XY coordinates data converted in S02 (S03).

Then, the height of the stage 5 is adjusted so that the height of the specimen is coplanar with the plane of focus F. For that purpose, a focused position where the contrast of the microscope is maximized is calculated. The contrast evaluation equation (1) which is made up of microscope image data is used for the quantitative evaluation of the contrast to be described below.

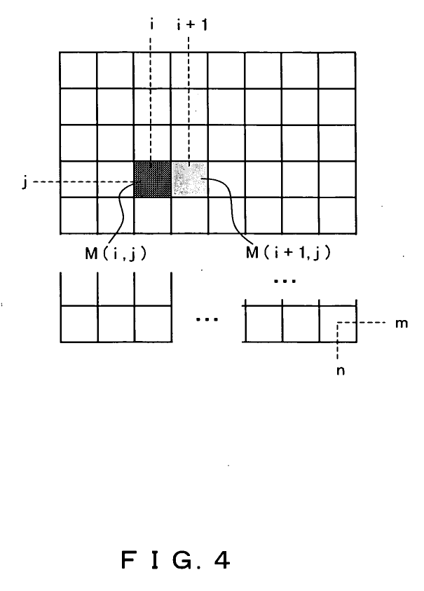

FIG. 4 explains the calculation of the contrast value in this preferred embodiment. A contrast value is obtained by multiplying a plurality of differences in luminance value between two pixels of adjacent image data on the same scanning line and summing them across the entire microscope image. It is determined that the higher this contrast value is, the higher the contrast. In FIG. 4, there is a microscope image made up of n×m pixels, and the difference in luminance value M between adjacent pixels (i, j) and (i+1, j) of them is |M(i, j)−M(i+1, j)|. Therefore, a plurality of these differences are multiplied and summed up across the entire microscope image, the following contrast evaluation equation is obtained (in the following equation (1), N=positive number and f=contrast value)

$$f = {\sum }_{i , j = 0}^{i = n - 1 , j = m} \{ {( M ( i , j ) - M ( i + 1 , j ) \}}^{2 N} \qquad ( 1 )$$

A focused position is searched for by gradually Z-transferring the stage 5 (transferring the stage 5 in the Z-axis direction (optic axis direction), hereinafter the same applies) while calculating a contrast value f in a predetermined search range, and a position where the contrast value becomes the maximum value is detected. Firstly, the stage 5 is transferred to the lowest position in the Z-axis direction search range, a contrast value f is calculated according to equation (1), and the value is specified as an initial contrast value (S04).

Then, the stage 5 is minutely transferred upward (in the Z-axis direction) and a contrast value is calculated (S05). In this case, an optimal displacement ΔZ is predetermined based on the depth of focus of the object lens or the like with respect to the focused position detection. After the stage 5 is minutely transferred, a contrast value is calculated at the Z position (position (coordinates) at which the stage 5 stops in the Z-axis direction, hereinafter the same applies) as in S04.

Then, the contrast value is compared with the contrast value of the previous Z position (the initial value in the first time) (S06). In this preferred embodiment, the stage 5 is stopped at each interval of height and a contrast value is evaluated. However, alternatively, a particular specimen is transferred at a specific speed and two contrast values of image data obtained at specific times can be evaluated.

If in S06, the contrast value is larger than the previous value, it is determined that a focused position has not get been reached and the process returns to S05. If in S06, the contrast value is smaller than the previous value, it is determined that the previous value is the maximum contrast value, the position is determined to be a focused position Ps (Ps is the Z position of the stage 5) and the stage 5 is returned to the previous Z position (S07). Then, after the transfer of the stage 5 terminates, the fine needle retreated by the driving mechanism 33 of the micromanipulator is returned to the reference position Pn.

After the focus position Ps of a specimen is detected thus, the fine needle L is inserted into the specimen K and an injection process is performed (S08). A fine needle is transferred in the X direction using the driving mechanism 33 of the micromanipulator and is inserted in the specimen. Then, an injection process starts. Then, it is determined whether there is a subsequent specimen into to which injection is applied (S09). If there is an unprocessed specimen, the process returns to S03, and S03 through S09 are executed as described above. The processes are repeated until they are applied to all specimens.

In a system having a configuration in which a specimen is focused by Z-transferring the object revolver 4, the following correction is made (S100). In this case, if the object revolver 4 is Z-transferred as the focus process of a specimen (in this case, in S04, S05 and S07, the object revolver 4 is Z-transferred), the plane of focus Pn of the fine needle L is transferred. Therefore, by correcting the height by transferring the fine needle in the Z direction by a distance the same as the Z-transfer of the object revolver 4 when a specimen is focused, the same effect can be obtained.

If the injection position of a specimen (position where a fine needle is inserted into a specimen) is different from the focus position of the specimen due to the thickness of the specimen, the difference can also be stored and this difference can also be corrected for (S101). As to such a specimen, the Z position of a fine needle can be corrected by storing this difference in advance (this difference can be calculated theoretically or experimentally obtained) for each type of specimen. Alternatively, the difference can be determined for each type of the specimen, depending on the size of the specimen and the surrounding environment (including factors such as temperature, humidity, pressure, composition; air, inert gas current, type or density of a culture solution, etc.).

As described above, S01 is only applied when the position Pn deviates due to the exchange of a fine needle or when the coordinates of the position Pn are cleared due to the restart of the device.

In this preferred embodiment, the contrast state of a microscope image for the focus process of a specimen is used. However, it is not limited to this method, and focus can also obtained using infrared red laser or the like. Specifically, a specimen is irradiated with an infrared lasers or the like, and focus can be formed on a specimen, a specimen container or the like, by a method for measuring the intensity of reflected light and detecting its focus position. If focus is formed on the container, the injection position must be determined taking the thickness of the specimen into consideration. The method of detecting the intensity of reflected light is faster than the above-mentioned method for detecting contrast, and accordingly, the process time can be shortened.

Thus, since the vertical position of an injection position can be automatically adjusted, the micromanipulator can automatically and collectively operate on a plurality of specimens each with a different height. A position where an image has a maximum contrast value can also be specified as a focus position. The difference can be corrected at any time according to the type or the like of specimen. The method of detecting the intensity of reflected light can also be used.

As described above, according to this preferred embodiment, the height of a specimen and the height of an injection needle can be automatically adjusted. Therefore, the operability of the injection process can be improved and also its process time can be reduced.

### The Second Preferred Embodiment

In this preferred embodiment, if there are many specimens each with a different height, in order to accurately adjust the height of the injection position of a specimen, the height is controlled by the focus process so that the contrast value of the image data may become the maximum around the injection position of a specimen. Specifically, although in the first preferred embodiment, a position where the contrast value of the entire microscope image becomes the maximum is specified as a focus position, in this preferred embodiment, a position where the contrast value in a prescribed range of a microscope image is specified as a focus position.

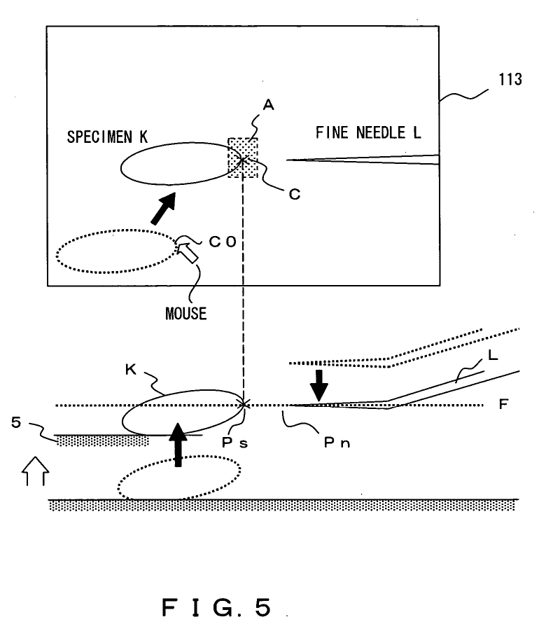

FIG. 5 shows an area A whose center is an injection position, in the second preferred embodiment. In this preferred embodiment, the contrast of image data in an area A including an injection position C (injection position on the XY-plane) is obtained and a focus position is calculated based on the contrast.

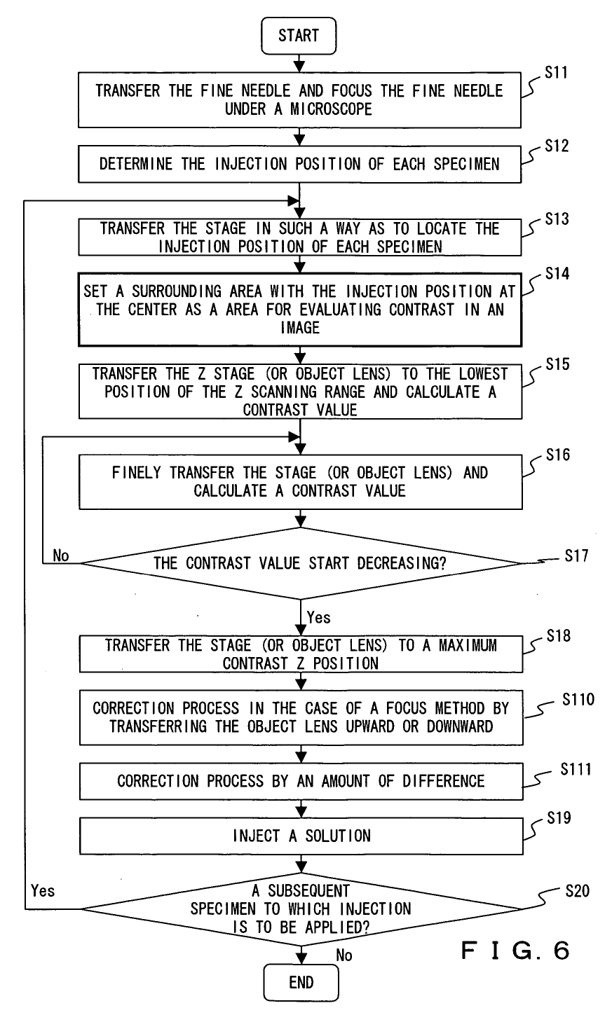

FIG. 6 shows the process flow of the second preferred embodiment. The processes in S11 through S13 until transferring the position where a fine needle is inserted into a specimen to the center of the screen after specifying an injection position are the same as those in S01 through S03 of FIG. 2.

The height of a point C of a specimen, where a injection process is performed, is as adjusted to that of a focus plane F. For that purpose, image data in a surrounding area A (for example, a square area whose two vertical and horizontal sides are approximately 100 pixels) whose center is the injection position C (injection position in the XY-coordinate system) is extracted (S14).

After that, a focus position where the contrast of the image data in the area A extracted in S14 becomes the highest is acquired for each specimen. The injection process in S15 through S20 after that is the same as that in S04 through S09 of FIG. 2.

In a system where the object revolver 4 Z-transfers, the object revolver 4 is Z-transferred in step S15, S16 and S18.

Correction processes S110 and S111 are the same as S100 and S102 shown in FIG. 2, respectively.

As described above, by calculating the contrast value of a prescribed image area of a microscope image, resources, such as CPU, memory and the like, can be effectively utilized, and accordingly, process speed can be improved.

As described above, according to this preferred embodiment, even when an injection process is applied to many specimens each with different height, height adjustment for each specimen can be automated. Accordingly, the operability of the injection process can be improved, and process time can be shortened.

### The Third Preferred Embodiment

In this preferred embodiment, a contrast value is calculated before starting focus processes for each specimen. If this value is larger than a preset value, the injection process is performed without a focus process. Specifically, if the contrast value is larger than a specified value, the Z position is regarded as a focus position and the injection process is performed.

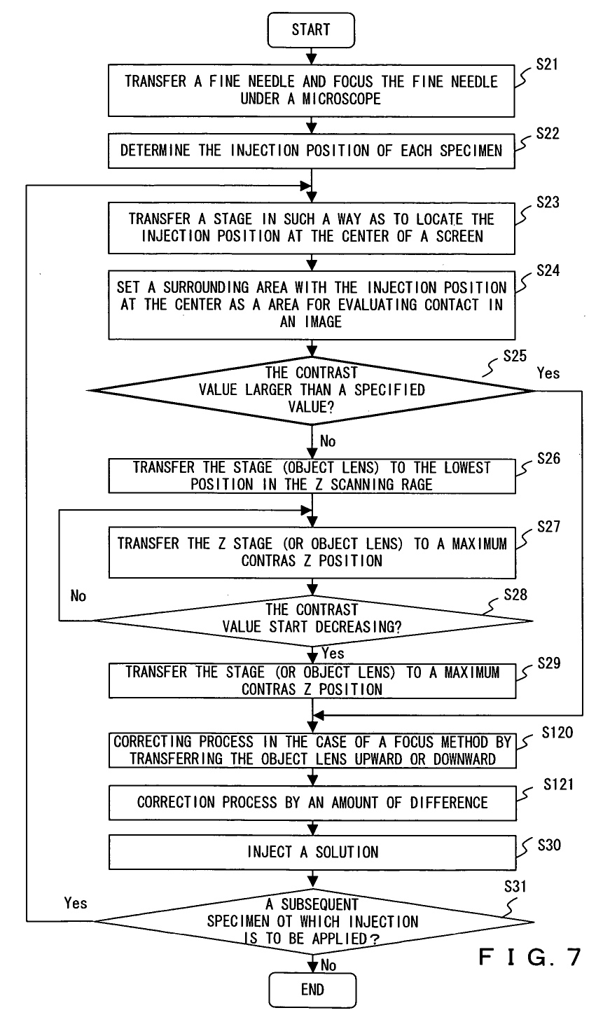

FIG. 7 shows the process flow of the third preferred embodiment. The processes in S21 through S24 until transferring the position of a specimen where the fine needle is placed at the center of a screen and specifying an area to which contrast evaluation is applied after specifying an injection position are the same as those in S11 through S14 of FIG. 6.

The contrast value in the area A set in step S24 is calculated, and is compared with a preset specification value (S25). In this case, the specification value can be determined based on an actual contrast value in the focus position obtained in an experiment or can be determined based on the ratio of the contrast value of the focus position in the first specimen.

In this case, if the calculated contrast value is smaller than the specification value, it is determined that the current Z position is still far away from the focus position, and the focus position detection processes of S26 through S29 is performed. This focus position detection process is the same as that in S15 through S18 of FIG. 6.

If the calculated contrast value is larger than the specification value, it is determined that the contrast of the image is located in the vicinity of the focus position since it is high, and an injection process is performed in step S30 without executing the focus position detection processes of S26 through S29. S23 through S30 are repeated until all specimens have been processed (S31).

In a system where the object revolver 4 Z-transfers, the object revolver 4 is Z-transferred in S26, S27 and S29.

Correction processes S120 and S121 are the same as those in S100 and S101, respectively, of FIG. 2.

Thus, by regarding all positions with a value equal to or larger than the threshold as focus positions, process speed can be improved.

As described above, according to this preferred embodiment, when transferring to a specimen with almost the same height, the injection process can be performed without a focus operation, and process time can be further shortened compared to the first preferred embodiment.

### The Fourth Preferred Embodiment

This preferred embodiment simultaneously performs an operation to transfer an injection position to the center of a screen for each specimen and a focus process.

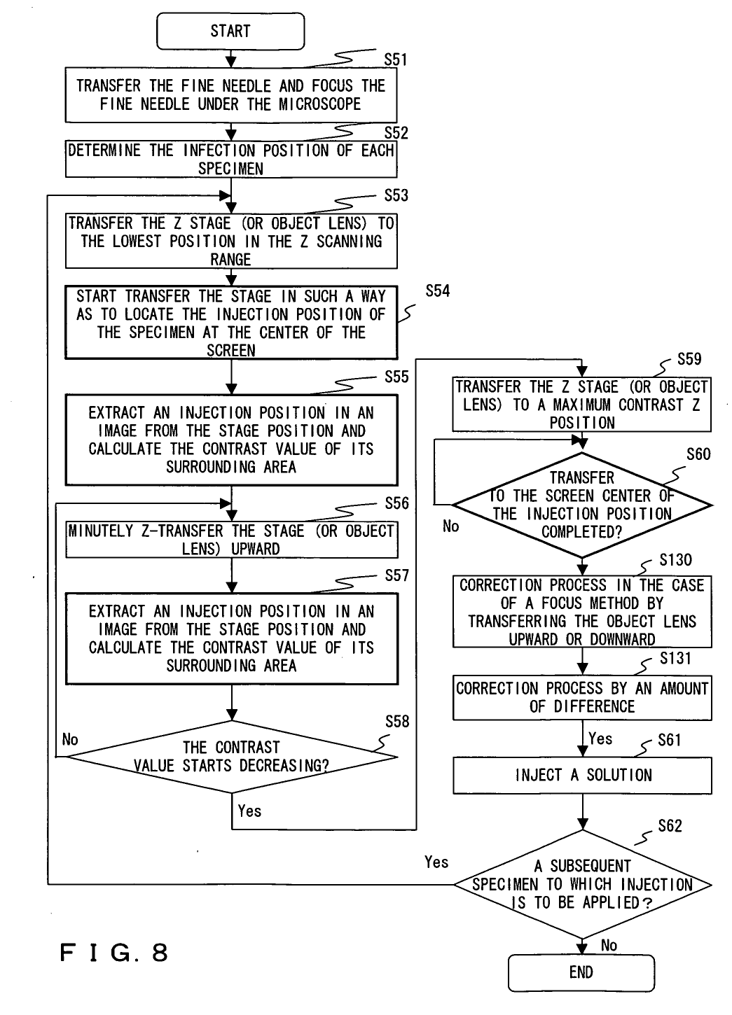

FIG. 8 shows the process flow of the fourth preferred embodiment. Processes of S51 and S52 until determination of the injection position of each specimen are the same as those of S11 and S12 of FIG. 6. The stage 5 is transferred to the lowest position in the Z-axis direction (S53).

The transfer starts in such away that an injection position is located at the center of the screen (S54).

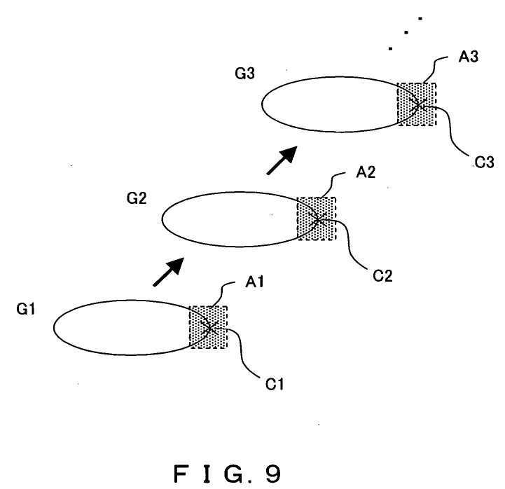

FIG. 9 shows the process in which an injection position C and its surrounding area A change their positions according to the transfer of the stage 5 when a specimen K mounted on the stage 5 is transferred in the direction of the arrows. In FIG. 9, the injection position C is transferred to C1, C2, C3 and so on. The surrounding area A transfers to A1, A2, A3 and so on.

During the transfer of the stage 5, the coordinates of the stage 5 are detected in real time, and the injection position on a displayed image is calculated based on the coordinate values. G1, G2 and G3 shown in FIG. 9 are the positions of a specimen in each focus process performed due to the transfer of the stage 5. In this case, in the first focus process when a specimen is located at stage position G1, the coordinates of injection position C1 are obtained.

Surrounding area A1 whose center is position C1, is specified as an area whose contrast value is calculated. A contrast value is calculated based on the image data of this specified area A1 (S55).

The stage 5 is minutely transferred upward (in the Z-axis direction) (S56). The current stage position G2 is detected. Injection position C2 in a microscopic image is extracted. The contrast value of surrounding area A2 is calculated (S57).

In this case, injection position C2 can be calculated using the coordinates of injection position C1 and the displacement of the stage 5. The range of the coordinates indicating surrounding area A2 is also obtained, and surrounding area A2 in the current microscope image, corresponding to the range of these coordinates are obtained. Then, a contrast value is calculated based on the surrounding area A2 of the appropriate microscope image. The respective contrast values of the surrounding area A1 in the previous microscope image (image at stage position G1) and the surrounding area A2 in the current microscope image are compared (S58).

If in S58, the contrast value is larger than the previous value, the process returns to S56, and the new coordinates G3 of the stage 5 are detected. Injection position C3 is calculated in a displayed image. After surrounding area A3 is set again, the contrast value on surrounding area A3 is calculated.

If in S58, the contrast value is smaller than the previous one, the contrast value of the previous position is determined to be the maximum. Therefore, it is determined that the previous stage position is a focus position, and the position is reset to the previous Z position (S59). The completion of the transfer in the horizontal direction of the stage 5 is awaited (S60).

Correction processes S130 and S131 are the same as S100 and S101, respectively, shown in FIG. 2.

When the transfer of the stage 5 is completed and the focus position of a specimen is detected, a fine needle is inserted into the specimen and a injection process is performed (S61). Furthermore, it is determined whether there is a subsequent specimen into to which injection is applied (S62). If there is another specimen, the process returns to S53. If there is no specimen, the process terminates.

In a system where the object revolver 4 Z-transfers, the object revolver 4 is Z-transferred in S53, S56 and S59.

Thus, in this preferred embodiment, as the stage is transferred on the XY plane, the coordinates to be acquired from each microscopic image differ. However, since the area to be extracted (surrounding an injection position) is the same, an image is always extracted from the surrounding of the injection position.

As described in the above-mentioned sequence of events, by tracing the coordinates of an injection position obtained in S52 (calculating an injection position using the coordinates and the amount of displacement of the stage 5), it can be detected at which coordinates of a microscope image photographed after the transfer of the stage 5 is located an injection position. If an area to extract can be specified, the process after that is the same as in the second preferred embodiment.

Thus, the horizontal transfer of an object and the accurate focus process of the specific part of the object (specimen) can be simultaneously performed.

As described above, according to this preferred embodiment, stage transfer for locating the injection position of a specimen at the center of a screen and a focus process can be simultaneously performed, and accordingly, injection process time can be shortened.

According to the present invention, a micro manipulation can be applied to many specimens accurately and for a short time, and accordingly, the operability of the micromanipulator is improved.

1. A micromanipulation system for applying a micro manipulation to an object within the view of a microscope, using a fine needle, comprising:
a manipulator driving unit for transferring the fine needle at least along the optic axis direction of the microscope,
a micro manipulation starting position determining unit for determining a micro manipulation starting position, from which the micro manipulation starts, using a position, on which the tip of the fine needle is focused in an object lens, as a reference position,
an object transfer unit for relatively transferring the respective positions of the object and object lens,
a focus position detecting unit for detecting a focus position indicating the focus of the object in the object lens, in accordance with the relative transfer of the object by the object transfer unit,
an object transfer control unit for controlling a movement of the object transfer unit, based on a detection result of the focus position detecting unit, and
a micro manipulation control unit for performing the micro manipulation in a state where the object is transferred to the focus position by the object transfer control unit and the fine needle is transferred to the micro manipulation starting position.

2. The micromanipulation system according to claim 1, wherein
said focus position detecting unit comprises
an image acquisition unit for acquiring images within the view of the microscope, according to the transfer of the object along the optic axis direction of the microscope;
a contrast value calculating unit for calculating a contrast value indicating the contrast height of the image acquired by the image acquisition unit; and
a maximum contrast value image detecting unit for detecting an image whose contrast value is the maximum from a plurality of images acquired by the image acquisition unit.

3. The micromanipulation system according to claim 1, further comprising
a correction unit for correcting the amount of transfer of said object transferring unit under the control of said object transfer control unit, according to at least one of the type, size and ambient environment of the object.

4. The micromanipulation system according to claim 1, wherein
said focus position detecting unit detects the strength of the reflected light of light applied to the object.

5. The micromanipulation system according to claim 2, wherein
said contrast value calculating unit calculates a contrast value in a predetermined area of the image, and
the predetermined area is an image area including a photographed area of the part of the object to be micro-manipulated.

6. The micromanipulation system according to claim 2, further comprising
a comparison unit for comparing the contrast value calculated by said contrast value calculating unit with a predetermined threshold value,
wherein
said maximum contrast value image detecting unit detects the maximum contrast value image, based on a result of the comparison by the comparison unit.

7. The micromanipulation system according to claim 2, further comprising
an object horizontal position detecting unit for detecting the position of the objects one after another in connection with the transfer of the objects in the horizontal direction, which is perpendicular to the optic axis,
wherein
said contrast value calculation unit calculates the contrast value in a prescribed area of an object photographed on the image, based on the information of the position detected by said horizontal position detecting unit.

8. The micromanipulation system according to claim 1, wherein
said micro manipulation starting position determining unit determines the micro manipulation starting position by correcting the reference position, based on a difference between the focus position of the object and an actual position of the object applied to be micro-manipulated.

9. The micromanipulation system according to claim 1, wherein
when said object transfer unit is of an object lens transfer type, said micro manipulation starting position determining unit corrects the reference position, based on the amount of transfer due to the transfer of said object transfer unit for the purpose of focusing the object.

10. A computer data signal which is embodied in a carrier wave in order to control a micromanipulation system for applying a micro manipulation to an object using a fine needle, for enabling a computer to execute a process, said process comprising:
a manipulator driving process of transferring the fine needle at least along the optic axis direction of the microscope,
a micro manipulation starting position determining process of determining a micro manipulation starting position, from which a micro manipulation starts, using a position, on which the tip of the fine needle is focused in an object lens, as a reference position,
an object transfer process of relatively transferring the respective positions of the object and object lens, a
a focus position detecting process of detecting a focus position indicating the focus of the object in the object lens, in accordance with the relative transfer of the object by the object transfer unit,
an object transfer control process of controlling a movement of the object transfer unit, based on a detection result of the focus position detecting unit, and
a micro manipulation control process of performing the micro manipulation in a state where the object is transferred to the focus position by the object transfer control process and the fine needle is transferred to the micro manipulation starting position.

11. The signal according to claim 10, wherein
said focus position detection process comprises
an image acquisition process of acquiring images within the view of the microscope, according to the transfer of the object in the optic axis direction of the microscope;
a contrast value calculating process of calculating a contrast value indicating the contrast height of the image acquired in the image acquisition process; and
a maximum contrast value image detecting process of detecting an image whose contrast value is the maximum from a plurality of images acquired in the image acquisition process.

12. The signal according to claim 11, said process further comprising
a comparison process of comparing the contrast value calculated in said contrast value calculating process with a predetermined threshold value,
wherein
said maximum contrast value image detecting process detects the maximum contrast value image, based on a result of the comparison in the comparison process.

13. The signal according to claim 11, said process further comprising
an object horizontal position detecting process of detecting the position of the objects one after another in connection with the transfer of the objects in the horizontal direction, which is perpendicular to the optic axis of the microscope,
wherein
said contrast value calculation process calculates the contrast value in a prescribed area of an object photographed in the image, based on the information of a position detected in said horizontal position detecting process.

14. A micromanipulation system control method for applying a micro manipulation to an object within the view of a microscope using a fine needle, comprising:
transferring the fine needle along the optic axis direction of the microscope;
determining a micro manipulation starting position, which is the optic axis direction position of the fine needle that starts the micro manipulation, using a optic axis direction position on which the tip of the fine needle is focused in an object lens as a reference position;
detecting a focus position indicating a position on which the object is focused in the object lens;
relatively transferring the respective positions of the object and the object lens position based on the result of the detection, and focusing the object on the object lens;
transferring the fine needle to the micro manipulation starting position; and
performing and controlling the micro manipulation.

15. The method according to claim 14, wherein
said detection process comprises
acquiring images within the view of the microscope, according to the transfer of the object along the optic axis direction of the microscope;
calculating a contrast value indicating the contrast height of the image; and
detecting an image whose contrast value is the maximum from a plurality of acquired images.

16. The method according to claim 15, further comprising
detecting the position of the objects one after another in connection with the transfer of the object in a direction perpendicular to the optic axis of the microscope,
wherein
the contrast value in a predetermined area of an object photographed on the image is calculated based on the information of the detected position.

17. A micromanipulation system for applying a micro manipulation to an object within the view of a microscope using a fine needle, comprising:
a manipulator driving unit for transferring the fine needle along the optic axis direction of the microscope and in a direction perpendicular to the optic axis direction;
an injection starting position determining unit for determining an injection starting position, which is the position of the fine needle that starts injection, using a position on which the tip of the fine needle is focused in an object lens as a reference position;
a stage for mounting the object and capable of being transferred so that the object lens of the microscope can observe the object;
a camera for acquiring images within the view of the microscope according to the transfer of the object along the optic axis direction of the microscope due to the transfer of the stage;
a contrast value calculating unit for calculating a contrast value indicating the contrast height of the images acquired by the camera;
a maximum contrast value image detecting unit for detecting an image whose contrast value is the maximum from the plurality of images, by repeating a comparison between the contrast value of the currently acquired image, calculated by the contrast value calculating unit and the contrast value of the previously acquired image, calculated by the contrast value calculating unit;
a microscope control unit for controlling the transfer of the stage to transfer the stage to a position where an image whose contrast value is the maximum is acquired, based on the detection result of the maximum contrast value image detecting unit; and
an injection control unit for performing the injection process in a state where the stage is transferred by the microscope control unit and the fine needle is transferred to the injection starting position.

18. The micromanipulation system according to claim 17, wherein
said contrast value calculating unit calculates the contrast value in a predetermined area of the image, and
the predetermined area is an image area having a predetermined area whose center is the part of the object to which injection is applied.

19. The micromanipulation system according to claim 17,
wherein
said injection starting position determining unit determines the injection starting position by correcting the reference position, based on a difference between the focus position of the object and an actual position of the object applied to be injection.

20. A micromanipulation system for applying a micro manipulation to an object with in the view of a microscope, comprising:
a manipulator driving unit for transferring the fine needle along the optic axis direction of the microscope and in a direction perpendicular to the optic axis direction;
an injection starting position determining unit for determining an injection starting position, which is the position of the fine needle that starts injection, using a position at which the tip of the fine needle is focused in an object lens;
a stage for mounting the object;
an object lens capable of being transferred along the optic axis direction to focus the object;
a camera for acquiring images within the view of the microscope according to the transfer of the object along the optic axis direction of the microscope due to the transfer of the stage;
a contrast value calculating unit for calculating a contrast value indicating the contrast height of the images acquired by the camera;
a maximum contrast value image detecting unit for detecting an image whose contrast value is the maximum from the plurality of images, by repeating a comparison between the contrast value of a currently acquired image, calculated by the contrast value calculating unit and the contrast value of the previously acquired image, calculated by the contrast value calculating unit;
a microscope control unit for controlling the object lens to transfer the object lens to a position where an image whose contrast value is the maximum is obtained, based on the detection result of the maximum contrast value image detecting unit; and
an injection control unit for performing the injection process in a state where the object lens is transferred by the microscope control unit and the fine needle is transferred to the injection starting position.

21. The micromanipulation system according to claim 20, wherein
said contrast value calculating unit calculates the contrast value in a predetermined area of the image, and
the predetermined area is an image area having a predetermined area whose center is the part of the object to which injection is applied.

22. The micromanipulation system according to claim 20, wherein
said injection starting position determining unit determining the injection starting opposition by correcting the reference position, based on a difference between the focus position of the object and an actual position of the object applied to be injection.

23. The micromanipulation system according to claim 20, wherein
said injection starting position determining unit corrects the reference position, based on the amount of transfer of the object lens for the purpose of focusing the object.

24. The micromanipulation system according to claim 20, further comprising
an object horizontal position detecting unit for detecting the position of the object one after another in connection with the transfer of the stage in the horizontal direction, which is perpendicular to the optic axis,
wherein
said contrast value calculation unit calculates the contrast value in a prescribed area of an object photographed on the image, based on the information of a position detected one after another.

25. A micromanipulation system for applying a micro manipulation to an object within the view of a microscope using a fine needle, comprising:
manipulator driving means for transferring the fine needle along the optic axis direction of the microscope and in a direction perpendicular to the optic axis direction;
injection starting position determining means for determining an injection starting position, which is the position of the fine needle that starts injection, using a position on which the tip of the fine needle is focused in an object lens as a reference position;
object transfer means for relatively transferring the respective positions of the object and the object lens;
focus position detecting means for detecting a focus position indicating a position where the object is focused in the object lens, according to the transfer of the object by the object transfer means;
object transfer control means for controlling the movement of the object transfer means, based on the detection result of the focus position detecting means; and
injection control means for performing the injection process in a state where the object is transferred to the focus position by the object transfer control means and the fine needle is transferred to the injection starting position.
